(19) United States
(12) Patent Application Publication
(10) Pub. No.: US 2010/0098332 A1
(43) Pub. Date: Apr. 22, 2010

(54) COMMUNICATION TERMINAL AND COMMUNICATION SYSTEM

(75) Inventor: Hitoshi Tsuchiya, Tokyo (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignee: OLYMPUS CORPORATION, Tokyo (JP)

(21) Appl. No.: 12/580,703

(22) Filed: Oct. 16, 2009

(30) Foreign Application Priority Data
Oct. 17, 2008 (JP) 2008-268711

(51) Int. Cl. G06K 9/00

(52) U.S. Cl. 382/166

(57) ABSTRACT

A communication terminal includes: an imaging unit which photoelectrically converts a subject image formed by an optical system into image data of which each frame is constituted by color data corresponding to a plurality of colors; a signal processing unit which thins out the color data corresponding to at least one color for each pixel in one frame from the image data; and a transmitting unit which transmits the image data processed by the signal processing unit to another communication terminal.

### BACKGROUND OF THE INVENTION

1. Field of the Invention

The present invention relates to a communication terminal transmitting image data acquired by imaging, a communication terminal receiving and displaying the image data, and a communication system including these communication terminals.

Priority is claimed on Japanese Patent Application No. 2008-268711, filed Oct. 17, 2008, the content of which is incorporated herein by reference.

2. Description of Related Art

In recent years, cameras corresponding to a wireless network such as a wireless LAN have come into wide use. In some cameras, a live view image can be seen in real time by receiving an image data via a wireless network and displaying the image data. With more advances in this technique, this technique is expected to be applied in a variety of fields. For example, a camera can be controlled or an instrument can be operated, while a remote image is seen.

As a system transmitting a live view image wirelessly, a wireless image transmission system which transmits an image data after the image data is compressed is disclosed in Japanese Unexamined Patent Application, First Publication No. H10-224771.

### SUMMARY OF THE INVENTION

In order to solve the above-mentioned problem and achieve the goal of the present invention, the present invention adopts the following configuration.

According to an aspect of the present invention, a first communication terminal includes: an imaging unit which photoelectrically converts a subject image formed by an optical system into image data of which each frame is constituted by color data corresponding to a plurality of colors; a signal processing unit which thins out the color data corresponding to at least one color for each pixel in one frame from the image data; and a transmitting unit which transmits the image data processed by the signal processing unit to another communication terminal.

According to another aspect of the present invention, a second communication terminal includes: a receiving unit which receives image data which is transmitted from another communication terminal and of which each frame is constituted by color data corresponding to one color or a plurality of colors; a data storing unit which stores the received image data; a data updating unit which updates only the color data, which corresponds to the color data contained in the received image data, in the image data stored in the data storing unit; and a display unit which displays an image based on the image data stored in the data storing unit.

The first communication terminal may further include an information acquiring unit which makes an inquiry regarding the characteristics of a display unit of another communication terminal and receives characteristic information on the characteristics of the display unit from another communication terminal. The signal processing unit may determine the color data to be thinned out in each pixel on the basis of the received characteristic information.

According to still another aspect of the invention, a communication system includes first and second communication terminals. The first communication terminal includes: an imaging unit which photoelectrically converts a subject image formed by an optical system into image data of which each frame is constituted by color data corresponding to a plurality of colors; a signal processing unit which thins out the color data corresponding to at least one color for each pixel in one frame from the image data; and a transmitting unit which transmits the image data processed by the signal processing unit to the second communication terminal. The second communication terminal includes: a receiving unit which receives the image data which is transmitted from the first communication terminal and of which each frame is constituted by color data corresponding to one color or a plurality of colors; a data storing unit which stores the received image data; a data updating unit which updates only the color data, which corresponds to the color data contained in the received image data, in the image data stored in the data storing unit; and a display unit which displays an image based on the image data stored in the data storing unit.

### BRIEF DESCRIPTION OF THE DRAWINGS

FIG. 1 is a block diagram illustrating the configuration of a communication terminal according to an embodiment of the present invention.

FIG. 2 is a diagram illustrating the configuration of a communication system according to the embodiment of the present invention.

FIG. 3 is a diagram illustrating a storage type of image data according to the embodiment of the present invention.

FIG. 4 is a diagram illustrating the storage type of image data according to the embodiment of the present invention.

FIG. 5 is a diagram illustrating the storage type of image data according to the embodiment of the present invention.

FIG. 6 is a diagram illustrating the storage type of image data according to the embodiment of the present invention.

FIG. 7 is a diagram for explaining a method of transmitting the image data according to the embodiment of the present invention.

FIG. 8 is a diagram for explaining the method of transmitting the image data according to the embodiment of the present invention.

### DETAILED DESCRIPTION OF THE INVENTION

Hereinafter, a preferred embodiment of the present invention will be described with reference to the drawings.

The preferred embodiment of the present invention will be described in detail to further clarify the gist of the present invention, but the present invention is not limited to the embodiment unless otherwise specified.

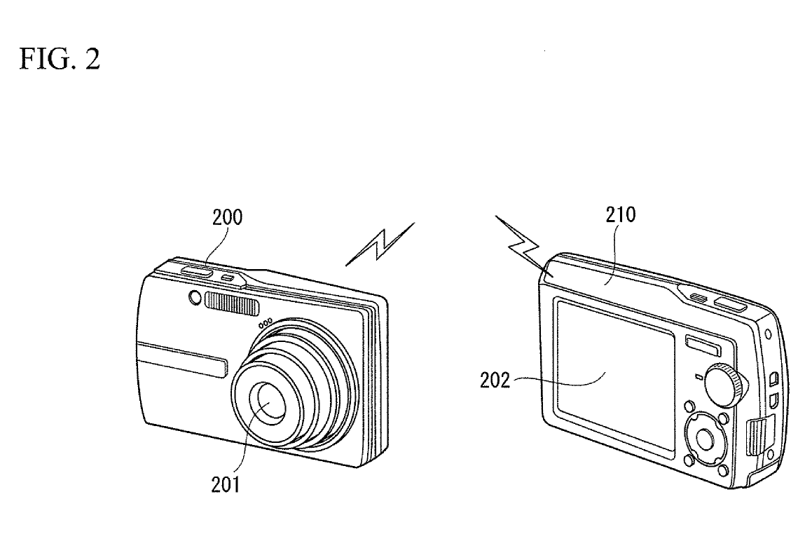

FIG. 2 is a diagram illustrating a configuration of a communication system according to a first embodiment of the invention.

In FIG. 2, a camera 200 served as a first communication terminal and a camera 210 served as a second communication terminal are connected to each other via a wireless network (wireless LAN or the like).

It is assumed that the cameras 200 and 210 are connected to each other not via an access point or a router but by ad-hoc connection. Since the cameras 200 and 210 have the same configuration, the cameras 200 and 210 can be served as either a transmitting device or a receiving device. Hereinafter, it is assumed that the camera 200 is served as the transmitting device and the camera 210 is served as the receiving device. An image photographed by a photographic lens 201 of the camera 200 is displayed on a display panel 202 of the camera 210 in a real time.

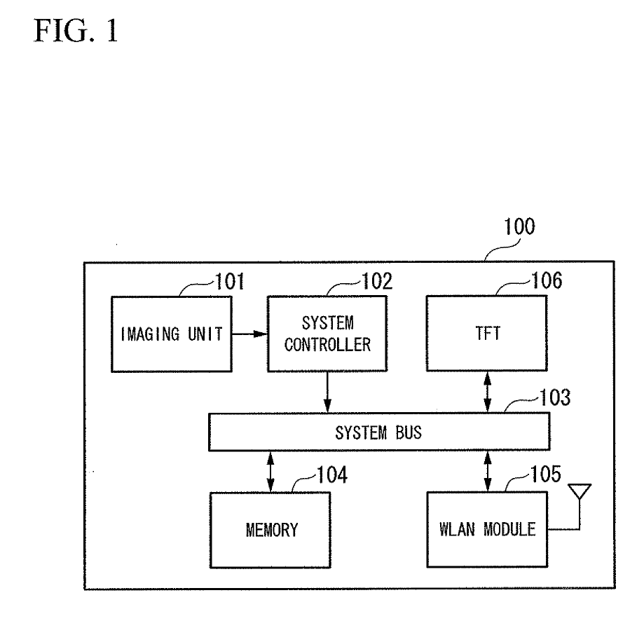

FIG. 1 is a block diagram illustrating the configuration of a communication terminal according to an embodiment of the present invention.

In FIG. 1, a communication terminal 100 corresponds to either the camera 200 or 210 in FIG. 2. The communication terminal 100 includes an imaging unit 101, a system controller 102, a system bus 103, a memory 104, a WLAN module 105, and a TFT 106.

The imaging unit 101 photoelectrically converts a subject image formed by an optical system corresponding to the photographic lens 201 into an imaging signal. In addition, the imaging unit 101 also executes signal processes such as a noise removing process or an A/D conversion process for the imaging signal, converts the imaging signal into image data, and outputs the converted image data to the system controller 102. The image data is constituted of a plurality of frames. Each of the frames is constituted of color data of a plurality colors.

The system controller 102 converts the format of the input image data into a predetermined format and stores the image data in the memory 104 via the system bus 103. The format of the image data stored in the memory 104 is described below. The system controller 102 executes a variety of control processes such as controlling each unit and controlling the operation mode of a camera as well as the process of converting the format of the image data. However, processes irrelevant to the present invention are not described.

The system bus 103, which is a bus that connects data lines between blocks, is capable of transmitting data between the blocks at a high speed. The memory 104 temporarily stores the image data and stores information necessary for the operations of the units.

The WLAN module 105 transmits to and receives data from another communication terminal by wireless communication.

When data is transmitted, the data is read from a designated area of the memory 104 by a DMA (Direct Memory Access) and the data is transmitted to another communication terminal by the WLAN module 105 under the control of the system controller 102. When the data is received, the data is received from another communication terminal by the WLAN module 105 and the data is transmitted by the DMA to an area of the memory 104 designated by the system controller 102. In the DMA, each function module connected to the system bus 103 gains direct access to the memory 104 without the control of the system controller 102.

The TFT 106 has a configuration corresponding to that of the display panel 202 in FIG. 2. The TFT 106 reads the image data from the memory 104 and displays an image based on the image data. The area from which the image data is read and the format of the image data is set in advance by the system controller 102.

### First Exemplary Operation

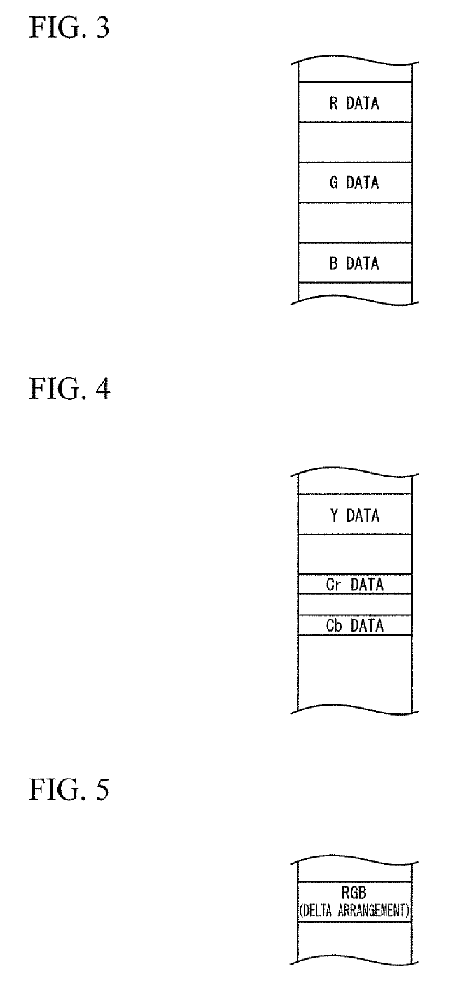

Next, a first exemplary operation will be described. FIG. 3 is a diagram schematically illustrating the arrangement of the image data in the memory 104. Data of RGB colors are separated and stored in a frame sequential method. Alternatively, the memory 104 may not be configured such that the areas divided as in FIG. 3 each have two frames and the data is simultaneously written and read in the same area.

The TFT 106, which is a TFT of the QVGA size, displays an image with 320×240 pixels on the basis of the image data stored in the memory 104. The conversion of the area of the memory 104 to read the image data for display is executed by the system controller 102. The image size of the QVGA is formed with 76800 (320×240) pixels. Since the amount of data per pixel is one byte, the total amount of the color data is 76800 bytes in total.

In the first exemplary operation, the color data corresponding to two colors are thinned out from the image data, which is constituted by the color data corresponding to three colors, and thus only the color data corresponding to one color is transmitted. FIG. 7 is a diagram illustrating the relationship between the displacement of a frame and the time of transmitting data in the imaging unit 101. In each frame, only the color data corresponding to one color is transmitted.

Hereinafter, the specific operation will be described. In the transmitting camera 200, the imaging unit 101 sequentially converts the subject image into the image data and outputs the converted image data to the system controller 102. The system controller 102 executes a data converting process for display and stores the RGB color data having the format shown in FIG. 3 in the memory 104. When the system controller 102 stores the image data corresponding to one frame in the memory 104, the system controller 102 changes the storage area in the memory 104, determines the color of data to be transmitted, designates the head address of the area of the data to be transmitted, and reads the data by the DMA. The WLAN module 105 transmits the data read from the memory 104 by the DMA to the receiving camera 210.

In the camera 210, the data received by the WLAN module 105 is sent to the memory 104 by the DMA and stored in the area of the color data corresponding to the received color data. The TFT 106 reads the image data stored in the memory 104 and displays the image based on the image data. At this time, the color data corresponding to three colors RGB are read. Since the color data corresponding to only one color is updated in one frame, a false color often occurs in the contour of the image of a rapidly moving subject. However, since a frame rate faster than a predetermined rate is ensured, the visibility of the moving subject is not considerably damaged.

By transmitting the color data corresponding to only one color in every frame, as described above, the amount of the data can be inhibited to ⅓. For example, in order to display the data of the QVGA at a frame rate of 15 fps, the communication execution rate is required to be 3.072 Mbps. Moreover, since no compression circuit is required, it is possible to prevent the size of the circuit from being increased or to prevent delays relevant to compression and extension from occurring.

### Second Exemplary Operation

Next, a second exemplary operation will be described. In the second exemplary operation, the image data is handled as a complementary color. FIG. 4 is a diagram schematically illustrating the arrangement of the image data in the memory 104. The data format in the second exemplary operation is the format of YC 422. For example, in the QVGA, the amount of the Y data is 76800 bytes and the amount of the Cr data and of the Cb data are each 38400 bytes.

FIG. 8 is a diagram illustrating the relationship between the displacement of a frame and the time of transmitting data in the imaging unit 101 in the second exemplary operation. The Y data is transmitted in every other frame. The Cr data and the Cb data are transmitted in every other frame in the same frame.

In the second exemplary operation, like the first exemplary operation, when the communication execution rate is 3.072 Mbps or more, the data can be displayed at a frame rate of 15 fps. In the first exemplary operation, an image is updated every three frames. In the second exemplary operation, however, an image is updated every two frames. As a consequence, it is possible to inhibit a deterioration in the quality of the moving subject more than in the first exemplary operation.

### Third Exemplary Operation

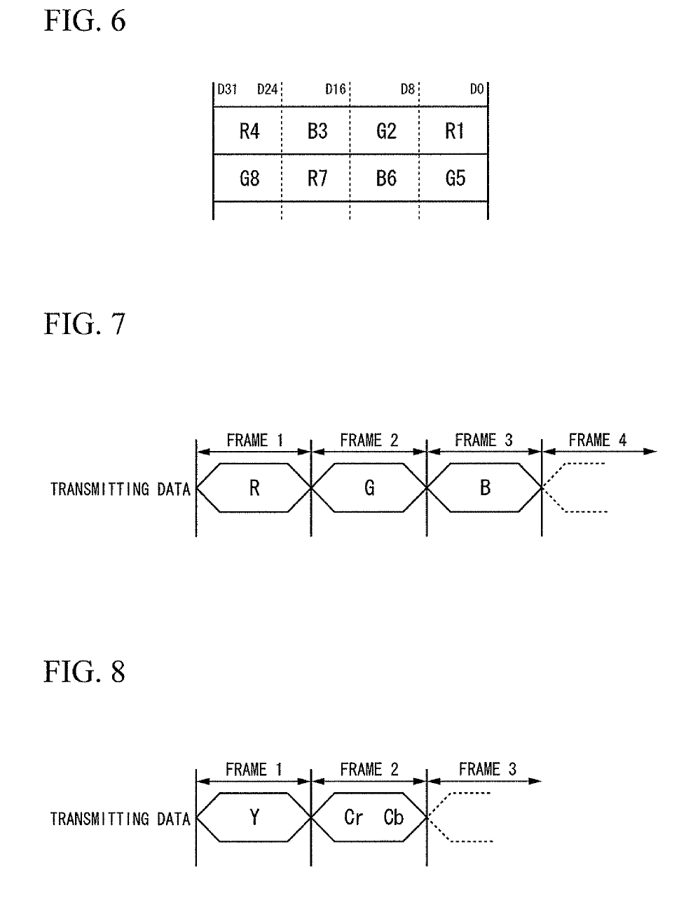

Next, a third exemplary operation will be described. In the third exemplary operation, the TFT 106 of the camera 210 served as a display terminal is a TFT with a delta arrangement. The delta arrangement means that one color is designated for each pixel. FIG. 5 is a diagram schematically illustrating the arrangement of the image data in the memory 104. In the delta arrangement, the color data of only one color are stored for each pixel in order of RGB. FIG. 6 is a diagram illustrating the detailed arrangement of FIG. 5. Since the image size is 76800 (320×240) pixels in the QVGA and the amount of data per pixel is one byte, the amount of the image data corresponding to one frame is 76800 bytes.

In the third exemplary operation, characteristic information on the characteristics of the TFT 106 relevant to the format of the data stored in the memory 104 is transmitted and received in advance between the transmitting camera 200 and the receiving camera 210. Specifically, the system controller 102 of the transmitting camera 200 transmits inquiry information to inquire the characteristics of the TFT 106 of the camera 210 via the WLAN module 105. On the other hand, in the camera 210, the inquiry information received by the WLAN module 105 is notified to the system controller 102. The system controller 102 transmits the characteristic information, which is stored in advance in an internal ROM and represents the format (the delta arrangement or another format) or the number of pixels of the TFT 106, to the camera 200 via the WLAN module 105.

In the camera 200, the characteristic information received by the WLAN module 105 is notified to the system controller 102. The system controller 102 identifies the characteristics of the TFT 106 of the camera 210 on the basis of the characteristic information. When the pixel arrangement of the TFT 106 can be known to be the delta arrangement, the system controller 102 determines a record format corresponding to the delta arrangement. In other words, the system controller 102 determines the color data corresponding to the color thinned out in each pixel to correspond to the delta arrangement.

The system controller 102 records the image data in the determined record format in the memory 104. That is, the image data output from the imaging unit 101 is constituted by the color data corresponding to three colors for each pixel, but the color data corresponding to two colors for each pixel are thinned out to be stored in the memory 104.

In the third exemplary operation, all of the data shown in FIG. 5 in each frame are transmitted. However, when the communication execution rate is 3.072 Mbps or more, the data can be displayed at the frame rate of 15 fps. In addition, since all of the data required for the display are updated in each frame, the image quality of the moving subject does not deteriorate.

While preferred embodiments of the invention have been described and illustrated above, it should be understood that these are exemplary of the present invention and are not to be considered as limiting. Additions, omissions, substitutions, and other modifications can be made without departing from the scope of the present invention. For example, as for the format of the image, the three formats have been used above. However, the invention is not limited thereto. Moreover, the image data formed after the color data are thinned out may be compressed using a compression circuit.

According to the invention, since the color data corresponding to at least one color for each pixel in one frame and then the image data is transmitted, it is possible to reduce the size of the data without providing an image compression circuit.

What is claimed is:

1. A communication terminal comprising:
an imaging unit which photoelectrically converts a subject image formed by an optical system into image data of which each frame is constituted by color data corresponding to a plurality of colors;
a signal processing unit which thins out the color data corresponding to at least one color for each pixel in one frame from the image data; and
a transmitting unit which transmits the image data processed by the signal processing unit to another communication terminal.

2. A communication terminal comprising:
a receiving unit which receives image data which is transmitted from another communication terminal and of which each frame is constituted by color data corresponding to one color or a plurality of colors;
a data storing unit which stores the received image data;
a data updating unit which updates only the color data, which corresponds to the color data contained in the received image data, in the image data stored in the data storing unit; and
a display unit which displays an image based on the image data stored in the data storing unit.

3. The communication terminal according to claim 1, further comprising:
an information acquiring unit which makes an inquiry regarding the characteristics of another communication terminal and receives characteristic information on the characteristics of the display unit from another communication terminal,
wherein the signal processing unit determines the color data to be thinned out in each pixel on the basis of the received characteristic information.

4. A communication system comprising first and second communication terminals,
wherein the first communication terminal includes:
an imaging unit which photoelectrically converts a subject image formed by an optical system into image data of which each frame is constituted by color data corresponding to a plurality of colors;
a signal processing unit which thins out the color data corresponding to at least one color for each pixel in one frame from the image data; and
a transmitting unit which transmits the image data processed by the signal processing unit to the second communication terminal,
wherein the second communication terminal includes:
a receiving unit which receives the image data, which is transmitted from the first communication terminal and of which each frame is constituted by color data corresponding to one color or the plurality of colors;
a data storing unit which stores the received image data;
a data updating unit which updates only the color data, which corresponds to the color data contained in the received image data, in the image data stored in the data storing unit; and
a display unit which displays an image based on the image data stored in the data storing unit.
